(19) United States
(12) Patent Application Publication
(10) Pub. No.: US 2003/0075981 A1
(43) Pub. Date: Apr. 24, 2003

(54) Car door safety device

(76) Inventor: Peter Kee Chen, Marietta, GA (US)

Correspondence Address: ROSENBERG, KLEIN & LEE, 3458 ELLICOTT CENTER DRIVE-SUITE 101, ELLICOTT CITY, MD, 21043, US

(21) Appl. No.: 09/983,353

(22) Filed: Oct. 24, 2001

(51) Int. Cl. B60R 25/04

(52) U.S. Cl. 307/10.1

(57) ABSTRACT

A car door safety device is formed by serially connecting a car-door-opened alarm device with an alarm switch and then is parallelly connected to an ignition control circuit. Two ends thereof being connected to a positive and negative polarities of a power source. The ignition control circuit is formed by a single shooting switch, a ignition control switch and a high voltage ignition coil. The ignition control switch includes a plurality of parallel-connected switches. When the car is being driven or is to be driven while the car door is not closed, other than the car-door-opened alarm device will be actuated to alert the driver, and the engine will turn off. Therefore, the present invention has the functions of promise and control so as to improve the safety of cars.

### FIELD OF THE INVENTION

The present invention relates to safety devices, and especially to a car door safety device having the functions of alerting an accident and controlling a motor to stop so as to improve the safety of cars.

### BACKGROUND OF THE INVENTION

Safety is the most important requirement for drivers and thus the manufacturers of cars make great efforts in improving the safety of driving a car. In general, a car door safety device includes a car door contact switch and car-door-opened indicator lamp connected to the instrument cluster. Only all car doors are closed, the indicator lamp is switched off.

For abovesaid car-door-opened alarm device, if one of any door does not close properly and the driver does not take attention to the indicator lamp in the instrument cluster, it is very dangerous as the driver drives the car at that time.

### SUMMARY OF THE INVENTION

Accordingly, the primary object of the present invention is to provide a car door safety device formed by serially connecting a car-door-opened alarm device with an alarm switch and then being parallelly connected to an ignition control circuit. Two ends thereof being connected to a positive and negative polarities of a power source. The ignition control circuit is formed by a single shooting switch, a ignition control switch and a high voltage ignition coil. The ignition control switch includes a plurality of parallel-connected switches. When the car is being driven or is to be driven while the car door is not closed, other than the car-door-opened alarm device will be actuated to alert the driver, and the engine will shut off. Therefore, the present invention has the functions of alerting and controlling so as to improve the safety of cars.

The various objects and advantages of the present invention will be more readily understood from the following detailed description when read in conjunction with the appended drawing.

### BRIEF DESCRIPTION OF THE DRAWINGS

FIG. 1 is a structural schematic view of the circuit of the present invention.

FIG. 2 shows the connection of the devices in the present invention.

### DETAILED DESCRIPTION OF THE PREFERRED EMBODIMENTS

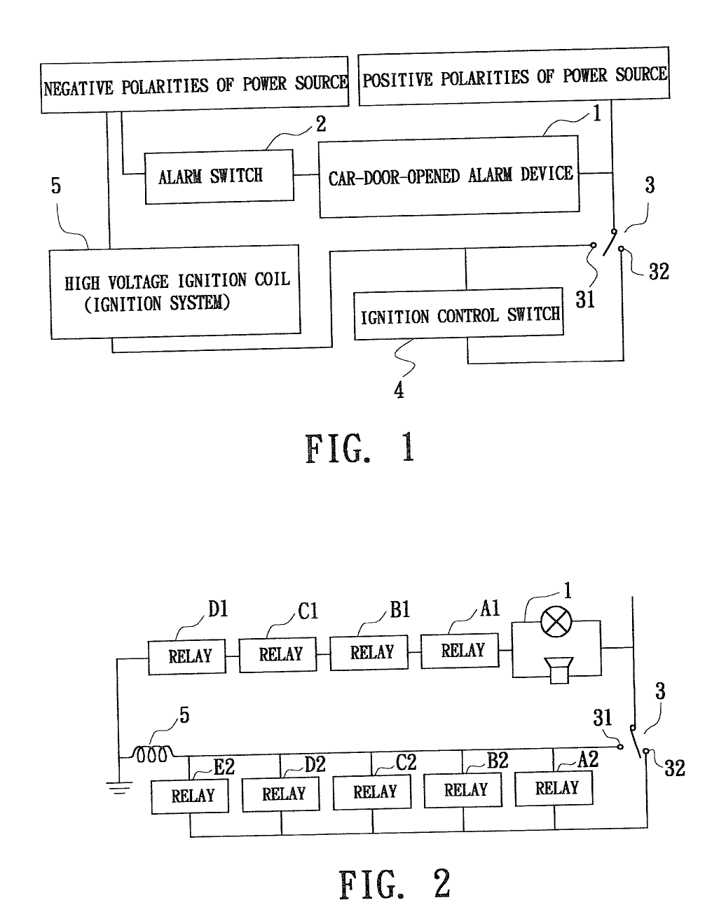

Referring to FIGS. 1, and 2, the car door safety device of the present invention is illustrated. The car door safety device of the present invention is formed by serially connecting a car-door-opened alarm device 1 with an alarm switch 2, and then the two devices being parallel connected to an ignition control circuit. Two ends thereof are connected to a positive and negative polarities of a power source.

The alarm switch 2 is formed by four switches connected in series, which are a car door contact switch A1 which is conducted as the car door is opened, an automatic transmission neutral switch B1 which is conducted as the automatic transmission gear is shifted to reverse OR driving gear position, parking brake switch C1 which is conducted as the parking brake is released, and brake padel contact switch D1 which is conducted as the brake padel is released.

The ignition control circuit is formed by a single shooting switch 3, a ignition control switch 4 and a high voltage ignition coil 5. The active shooting point of the single shooting switch 3 is connected to a positive polarity of the power source. One of the fixing joint 31 and the positive polarity of the high voltage ignition coil 5 are connected to one end of the ignition control switch 4, and another fixing joint 32 is connected to another end of the ignition control switch 4.

The ignition control switch 4 includes the following four parallel-connected switches which are a car door contact switch A2 which is turned off as the car door is opened, an automatic transmission neutral switch B2 which is turned off as the automatic transmission is shifted to reverse OR driving gear position, a parking brake contact switch C2 which is turned off as the parking brake is released, and a brake contact switch D2 which is turned off as the brake padel is released.

To avoid the normal operation of the power brake and steering assistance systems, the ignition control switch 4 is further installed with a speed sensing switch E2 which is turned off as the car speed is lower than 2 m/sec. The speed sensing switch E2 is connected with the switches A1, B2, C2, and E2 of the ignition control switch 4 in parallel.

In this system, the switches of the alarm switch 2 and the ignition control switch 4 are relays. To have a small volume and a lower cost, the alarm switch 2 is an AND circuit trigger 2 formed by logic elements. When the input of each sensing switch is at a high voltage, the AND circuit trigger will output a high voltage to conduct the alarm switch 2. The ignition control switch 4 may be performed by an OR circuit trigger. When the input of each sensing switch is at low voltage, the OR circuit trigger will output a low voltage to turn off the high voltage ignition coil 5.

Since in the present invention, the single shooting switch 3 is utilized to control the conduction of the ignition control switch 4, when the active contact point of the single shooting switch 3 is in contact with the fixing joint 31, the ignition control switch 4 is turned off. In this condition, when the car is being driven or is to be driven while the car door is not closed, the car door contact switch A1, automatic transmission neutral switch B1 parking brake contact switch C1, and brake contact switch D1 are conducted so that the car-door-opened alarm device 1 will be switched on to inform the driver. Thus, the active contact point of the single shooting switch 3 will contact the fixing joint 32, and the ignition control switch 4 and the alarm switch 2 actuates. In this condition, when the car is being driven or is to be driven while the car door is not closed, other than the car-door-opened alarm device 1 will be actuated to alert the driver, the car door contact switch A2, automatic transmission neutral switch B2, parking brake contact switch C2, and brake padel contact switch D2 of the ignition control switch 4 will be turned off so as to turn off the high voltage ignition coil 5. Thereby, the motor will stop so that the car stops.

In summary, in the present invention, the ignition control circuit is connected to the alarm switch 2 through the serial connected car-door-opened alarm device 1. The ignition control switch 4 in the ignition control circuit 1 includes a car door contact switch A2, an automatic transmission neutral switch B2, a parking brake contact switch C2, and a braking padel contact switch D2 which are connected in parallel. When the car is being driven or is to be driven while the car door is not closed, other than the car-door-opened alarm device will be actuated to alert the driver, and the high voltage ignition coil 5 will turn off.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A car door safety device being formed by serially connecting a car-door-opened alarm device with an alarm switch and then being parallelly connected to an ignition control circuit; two ends thereof being connected to a positive and negative polarities of a power source; wherein
the alarm switch is formed by four switches connected in series, which are a car door contact switch which is conducted as the car door is opened, an automatic transmission neutral switch in which is conducted as the automatic transmission gear is shifted to reverse or driving gear position, a parking brake contact switch which is conducted as the parking brake is released, and a brake padel contact switch which is conducted as the brake padel is released;
the ignition control circuit is formed by a single shooting switch, a ignition control switch and a high voltage ignition coil; and the ignition control switch includes the following four parallel-connected switches which are a further car door contact switch which is turned off as the car door is opened, a further automatic transmission neutral switch in which is turned off as the automatic transmission gear is shifted to reverse or driving gear position parking brake contact switch which is turned off as the parking brake is released, and a further brake padel contact switch which is turned off as the brake padel is released;
wherein the active shooting point of the single shooting switch is connected to a positive polarity of the power source; one of the fixing joint and the positive polarity of the high voltage ignition coil are connected to one end of the ignition control switch, and another fixing joint is connected to another end of the ignition control switch.

2. The car door safety device as claim in claim 1, wherein the ignition control switch is further installed with a speed sensing switch which is turned off as the car speed is lower than 2 m/sec. The speed sensing switch is connected with the switches of the ignition control switch in parallel.

3. The car door safety device as claim in claim 1, wherein the alarm switch is an AND circuit trigger.

4. The car door safety device as claim in claim 1, wherein each sensing switch in the alarm switch is a relay.

5. The car door safety device as claim in claim 1, wherein the ignition control switch is an OR circuit trigger.

6. The car door safety device as claim in claim 1, wherein each sensing switch in the ignition control switch is a relay.
